(19) United States
(12) Patent Application Publication
(10) Pub. No.: US 2015/0059240 A1
(43) Pub. Date: Mar. 5, 2015

(54) DEVICE FOR USE IN ARRANGING A BUNCH OF FLOWERS HAVING CORN-SHEAF-BOUND FLOWER STEMS

(71) Applicant: ARD. VAN BERS HOLDING B.V., Katwijk (NL)

(72) Inventor: Adrianus Dick Van Bers, Katwijk (NL)

(73) Assignee: ARD. VAN BERS HOLDING B.V., Katwijk (NL)

(21) Appl. No.: 14/380,346

(22) PCT Filed: Feb. 21, 2013
(86) PCT No.: PCT/NL2013/000004

§ 371 Date: Aug. 21, 2014

(30) Foreign Application Priority Data
Feb. 21, 2012 (NL) 1039397

(51) Int. Cl. A01G 5/02

(52) U.S. Cl. CPC A01G 5/02
USPC 47/41.13

(57) ABSTRACT

Device for use in arranging a bunch or bouquet of flowers (2) with corn-sheaf-bound or twisted-bound flower stems (3); the device is provided with grid plates (7, 5), which are substantially parallel horizontally oriented, and are provided with openings (6) suitable for inserting through flower stems (3), the grid plates (7, 5) being able to be rotated relative to one another about a common axis of rotation, wherein the upper grid plate is arranged to remain positioned in the bouquet of flowers (2) after the arranging. The lower grid plate (5) is non-rotatably mounted in the device and the upper grid plate (7) being rotatable about the common axis of rotation.

The invention relates to a device for use in arranging a bunch or bouquet of flowers with corn-sheaf-bound or twisted-bound flower stems; the device is provided with a first upper grid plate and with a second lower grid plate; the grid plates each being substantially parallel horizontally oriented, and being provided with openings suitable for inserting through flower stems; the upper and lower grid plates being able to be rotated relative to one another about a common, substantially vertical, axis of rotation, wherein the upper grid plate is arranged to be able to remain positioned in the bouquet of flowers after the arranging.

The invention also relates to a method for arranging a bunch of flowers into a corn-sheaf-bound bouquet with the device according to the invention, and relates to a grid plate for use with the device.

A device of this type is disclosed in the Korean Patent Application No. 2002-0090585 (XP002686221, “An Apparatus for forming bouquet”) in which two grid plates by means of an insert tube and a support shaft are mounted one above the other on a base plate. The base plate is provided with a vertical hollow tube in which the support shaft is inserted. The grid plates are in their centre provided with an opening, of which the diameter is larger than the outer diameter of the support shaft, but is smaller than the diameter of the hollow support tube and is also smaller than the vertical hollow tube of the base plate. In use the lower grid plate rests upon the vertical hollow tube of the base plate, and the upper grid plate rests upon the upper side of the support tube. The grid plates and the support tube are maintained in position by the support shaft, which extends from the vertical hollow tube of the base plate, through the grid plates and the interior of the support tube, to a position above the upper grid plate. After the flower stems are inserted into the openings in the upper grid plate and in the lower grid plate, the grid plates are rotated relative one another about the support axis, so that a corn-sheaf-bound bouquet of flowers is formed.

This device has the disadvantage that the two grid plates can freely move relative to each other, causing reversed rotation of the grid plates as a result of the torque forces in the bunch. It is therefore difficult to preserve the shape of the bunch and it is difficult to bound i.e. tie up the bunch. It is also disadvantageous that a support tube is present between the centre points of the grid plates, obstructing the twisting of the stems in the bunch or even damaging the stems of the flowers. With this known device forming and tying up by one person of visually identical bunches of flowers in a reproducible and efficient manner is difficult, requiring great skill and competence.

A device of this type is also disclosed in Dutch patent 1019351, with which the stems of the flowers, which are to be arranged into a corn-sheaf-bound bunch, are inserted through the openings in the upper grid and subsequently are inserted through the openings of the lower grid. By rotating the lower grid relative with respect to the upper grid, the flower stems are twisted into a double-cone-like shape, after which simply a tie, such as a rubber band, can be applied onto the most narrow or constricted portion of the double-cone-like shape. The upper grid is formed by two bar-gratings having parallel oriented bars, which bar-gratings can be horizontally shifted towards each other at an angle. Between the two shifted overlapping bar-gratings openings are formed suitable for inserting through flower stems. After the tie is applied to the bunch of flower stems, one bar-grating, or both bar-gratings, of the upper grid are shifted i.e. pulled away, out of the bunch of flowers, so that the corn-sheaf-bound bouquet can be removed from the device.

This known device has a number of disadvantages. Manually rotating the lower grid by the user is difficult because the centre of gravity is located high in the bunch of flowers. The construction of the upper grid is complicated because two sliding grating portions are used. Moreover it has been noticed that a bunch arranged in this device will lose quickly its corn-sheaf-like shape when the upper grid is removed, because the upper grid will not remain positioned in the bouquet. When the flowers within the bouquet are in particular arranged in a wide or hemispherical—corn-sheaf-like—double cone, the flowers at the top of the bouquet are widely spaced apart and may easily move towards each other again and/or tilt as a result of the lateral compressing forces exerted in the direction of the centre of the bunch during packaging of the bunch into a wrapping paper or an flower sleeve. As a result of this movement towards each other i.e. contraction of the flowers, the bouquet occupies less volume. In manually arranged bouquets by using the corn-sheaf technique often green flowerless branches or twigs are added between the flowers, in order to support the flowers in the bouquet and to render and keep the bouquet voluminous, even if compressing, lateral, forces are exercised on the bunch. With the corn-sheaf technique for arranging a bouquet, the stems of the flowers are rotated into each other; this is also referred to as twisted.

The invention also relates to a grid plate suitable for use in the device for use in arranging a bunch or bouquet of flowers with corn-sheaf-bound or twisted-bound flower stems; and suitable for use in the method according to the invention.

International patent application WO 0180693 discloses a disc or plastic grid plate for use in forming of a hand arranged bouquet, the plate being provided with openings for inserting through flower stems. The disc remains clamped in the bunch during sale, transportation and during use as home decoration in a vase. Openings are formed having eight wedge-shaped fingers, by providing four slits diametrically opposite to each other. Said known discs are not suitable for use in the device according to the present invention, because the flower stems can not be easily inserted through, caused by the flat surface of the disc so that consequently the openings can not be found easily and therefore are frequently missed by the user. As a result the time required to arrange a bouquet is high and the efficiency is low.

Object of the present invention is therefore to provided for an improved, robust, efficient, time-saving device and method for arranging a corn-sheaf-bound bunch of flowers, wherein the flower stems can be easily and quickly inserted, with which the corn-sheaf-bound bouquets can be easily, lightly, reproducibly formed without reverse rotation of the grid plates including the flower stems in the device and without damaging of the flower stems, with which bouquets of different sizes and having different lengths of the flower stems can be formed, with which the bouquets can be provided easily and efficiently with a tie, and with which the bouquet will be voluminous and will be able to retain its shape after removal from the device.

The object of the invention is achieved by providing a device, wherein the lower grid plate is non-rotatably mounted in the device and, wherein the upper grid plate is rotatable about the common axis of rotation.

By fixing the lower grid plate in the device and by providing the upper grid plate rotatably in the device, the bunch can not reversely rotate or twist, for example during applying the binding material around the stems by the user.

It is less demanding and difficult for the user to rotate the upper grid plate for obtaining a twisted bundle of flower stems, since the centre of gravity of the flowers generally is located high, and the rotation of the upper side of the bouquet can be aided by a rotating force (exercised by hand) on the crown of flowers.

In a preferred embodiment, the upper grid plate essentially is a circular flat disc, wherein the openings essentially are mutually arranged in regular equal distances from each other.

Through these measures, an orderly bunch of flowers is obtained having regularly distributed flowers within the bunch, so that with a small amount of flowers a voluminously and systematically uniform appearance is obtained of the bunch, wherein furthermore the bunch retains its volume when it is removed from the device according to the invention.

Preferred is the embodiment in which the device is provided with a first upper grid holder and with a second lower grid holder.

By mounting the grid plates in grid holders, it is possible to quickly adapt the device to the requirements of the bouquet to be arranged, such as the required number of flowers and the corresponding position of the flowers in the pattern selected for the bouquet. For each specific design for a bouquet a matching grid plate with appropriately configured openings can easily be applied as upper and/or lower grid plate.

In particular the first grid holder is arranged to be able to receive and rotate the upper grid plate.

In this manner a device is provided, which facilitates easy insertion into the grid holders of miscellaneous grid plates, for example having different patterns and/or openings, thereby facilitating easy rotation of the upper grid plate in the first grid holder.

More in particular the second grid holder is arranged to be able to non-rotatably receive the lower grid plate, and the second grid holder and the lower grid plate preferably being provided with fixing means in order to prevent rotation of the grid plate in the second grid holder. This has, inter alia, the advantage that a particular upper grid plate can also be applied as lower grid plate.

Preferably the first grid holder is provided with a holder body, which comprises a rotary ring, rotatable about the axis of rotation, the rotary ring being suitable for receiving the upper grid plate.

In particular the rotary ring and the upper grid plate are provided with fixing means.

More in particular the holder body comprises a cylindrical pivot recess and a support ring, wherein the rotary ring is mounted into the pivot recess and is resting upon the support ring.

With these measures, a grid holder is obtained having a simple and robust construction, which can be easily rotated by the user, and in which in a simple manner a specifically adapted grid plate can be applied for each different bouquet. The rotary ring preferably has a cylindrical shape corresponding to the cylindrical pivot recess. By means of the fixing means, such as ribs upon the rotary ring and corresponding recesses or slots on the grid plate, is prevented that the grid plate itself will rotate in the holder body and in the rotary ring.

In a preferred embodiment, an adapter piece is provided having a fitting hole, the piece being adapted to be able to receive grid plates having an extraordinary peripheral shape, and to attach these grid plates into a grid holder.

Using an adapter, also referred to as intermediate piece or transition part and for example realized as an adapter plate provided with a fitting hole having the same peripheral shape as the grid plate, enables to freely choose the configuration/pattern of the openings of the grid plate. Furthermore there is no need anymore to provide every grid plate for each bouquet design with a disk shape having a circular outer periphery for reception into the (cylindrical) rotary ring. The adapter is preferably provided with fixing means to fix the adapter (non-rotatably) within the grid holder and to fix the grid plate (non-rotatably) into the adapter.

In particular an adjustment mechanism is provided for adjusting the two grid holders relative to each other in the vertical direction. Thereby, the device can easily be adapted to the size of the bouquet and to the length of the flower stems.

Preferably the second grid holder with the second lower grid plate is adjustable in the vertical direction, so that the space between the lower grid plate and the bottom side of the first grid holder is adjustable. This allows for adjustment as desired of the position of the narrowest part of the double-cone shape of the flower stems arranged with the corn-sheaf technique. Consequently for example Biedermeiers (small, but wide, voluminous bouquets) can be arranged from flowers with long stems, by adjusting the second grid holder in vertical direction to a position close to the first grid plate, so that binding ties can be applied close to the flowers.

In order be able to process with the device a small bunch of flowers, such as a Biedermeier bouquet having small short stems, it is preferable according to the invention, that a third grid holder is provided for receiving a third grid plate, said third grid holder being adjustable in the vertical direction, so that the space between the third grid plate and the bottom side of the first grid holder can be adjusted.

The invention also relates to a method for arranging a bunch of flowers into a corn-sheaf-bound bouquet with the device according to the invention, comprising the steps:

inserting the upper grid plate with openings into the device;

inserting the flowers with its flower stems through the openings of the upper grid plate and subsequently through the openings of the lower grid plate;

rotating the upper grid plate for obtaining a twisted bunch of flower stems, having a double-cone shape;

applying a tie at or near the narrowest part of the double-cone shape of the twisted bunch of flower stems;

removing the assembly of the corn-sheaf-bound bouquet and the grid plate from the device.

Using a grid plate in the device according to the invention facilitates, even by inexperienced and unskilled flower arrangers, easily composing of a symmetrical and voluminous bouquet with the corn-sheaf technique. The grid plate remaining in the bouquet provides for support so that the shape is maintained even after the removal of the bouquet from the device. Because the upper grid plate is rotatable and the lower grid plate is not, an untrained user can easily and reproducibly now form a corn-sheaf-tied bouquet. It is for the user less heavy and difficult to rotate the upper grid plate because the centre of gravity of the flowers generally is located high and because exercising a rotating force on the crown of the flowers facilitates the rotation of the upper part of the bouquet.

The invention also relates to a grid plate suitable for use in the device for use in arranging a bunch or bouquet of flowers with corn-sheaf-bound or twisted-bound flower stems; and suitable for use in the method according to the invention.

In an advantageous embodiment the openings are provided with one or more bevelled surfaces, which decline in the direction of the opening. This facilitates the insertion of the flower stems by the user, because the bevelled surfaces guide the lower end of the flower stem in the direction of the opening.

In particular raised ribs are provided between two adjacent openings, with which slipping away of the lower end of the flower stem is prevented to a neighbouring opening, to allow for a faster and more efficient insertion by the user of flower stems in the grid plates.

More in particular the openings at the edges are provided with clamping means, such as one or more lips, which means extend in the direction of the centre of the opening; preferably the clamping means are flexible and resilient in such a way that the flower stems of the flowers each are clamped in an opening of the grate plate. By means of the clamping means, such as the lips provided in the openings, the flower stems are clamped into the openings, so that after removal of the corn-sheaf arranged bunch from the device, with the therein attached grid plate, the grid plate remains clamped in the desired position on the flower stems thereby providing lateral support to the flowers so that the bunch maintains its model and voluminous shape. The flexible lips are able to provide and exercise sufficient clamping force upon the stems, while the lips cause little or no damage to the stems.

In particular the lips located on the underside of the grid plate are concavely curved and outwardly extending, wherein the ends of the lips preferably have a substantially coaxial position. The probability of causing damage to the flower stem is hereby minimized, because during the insertion of the flower stem the (ends of the) lips substantially abut flatly against the surface of the stem and will slide over the surface of the flower stems, while nevertheless a large clamping force is exerted on the flower stem.

In an advantageous embodiment the peripheral shape is defined by the configuration and the pattern of the openings. A grid plate—provided with a peripheral shape determined by: the design of bouquet, the selected configuration and the pattern of the openings, without flat edge parts in order to obtain a disc-shaped, circular, peripheral shape—has the advantage that the grid plate, in absence of non-functional edge parts, is less clearly visible in the bouquet and also has the advantage that the contours are less likely to be visible through the packaging materials, for example, when the bouquet is (tightly) wrapped in a wrapping paper or is packaged in a flower sleeve.

The invention also relates to an assembly of a bunch or bouquet of flowers having corn-sheaf-bound flower stems and a grid plate having openings.

The invention will hereafter be explained in more detail by means of the drawing of an embodiment of the device, the assembly and the grid plate, wherein features and other advantages will come forward.

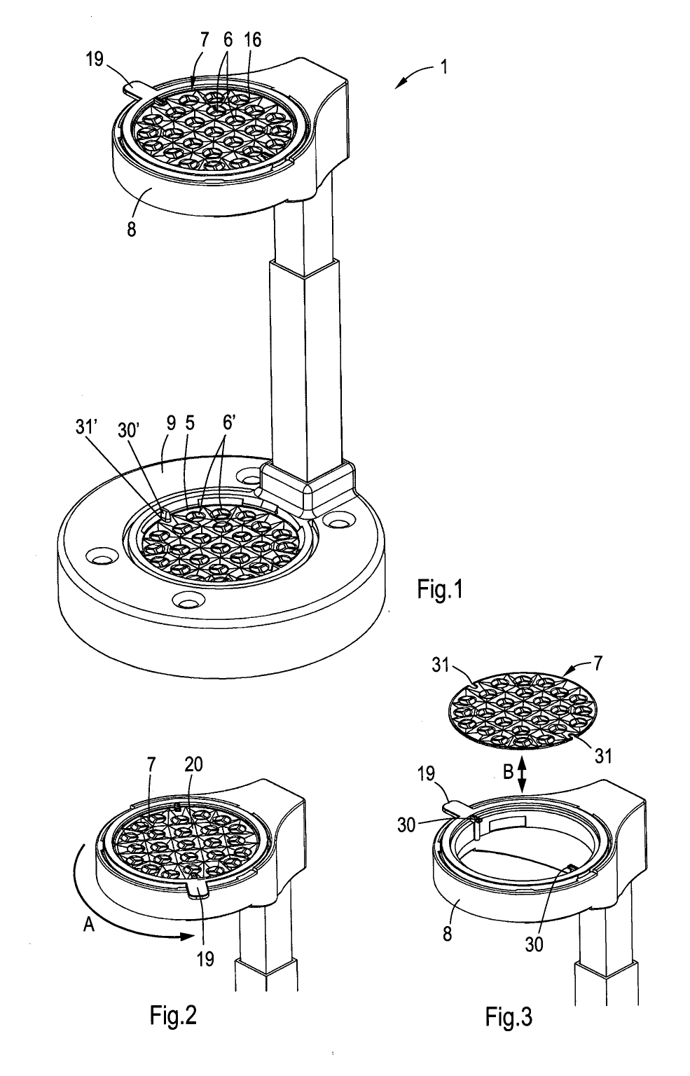

FIG. 1 shows in a perspective view the device according to the invention for arranging a bunch of flowers with the of corn-sheaf technique;

FIG. 2 shows in detail the first grid holder with the upper grid plate;

FIG. 3 shows the grid plate, which is detachable from the upper grid holder;

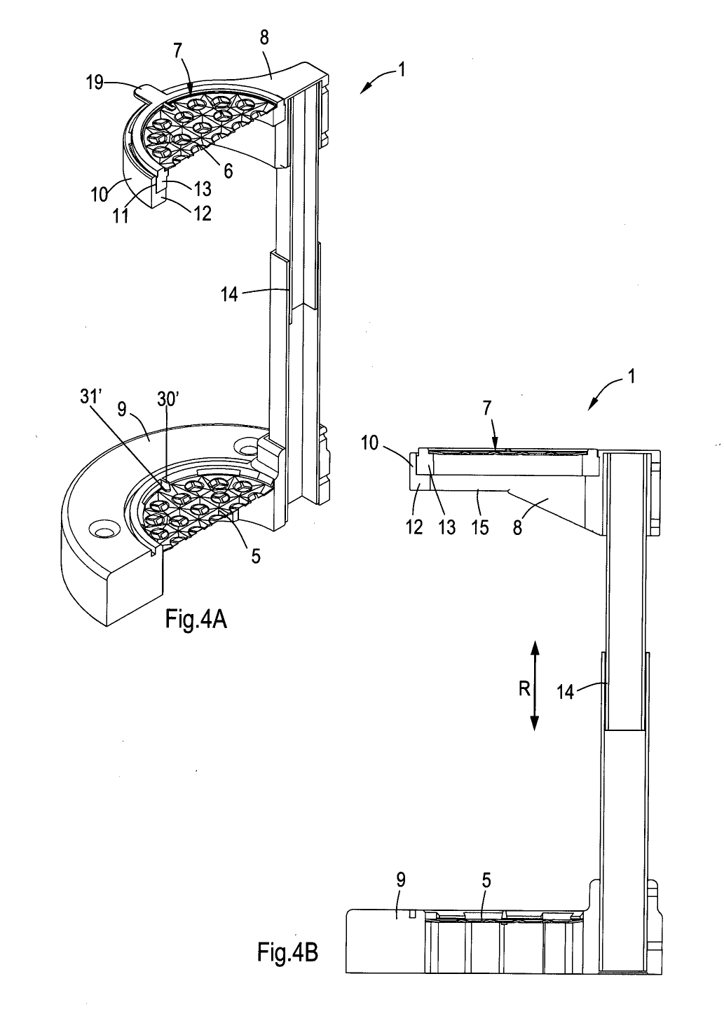

FIG. 4A shows a perspective sectional view of the device;

FIG. 4B shows a flat cross-section of the device of FIG. 4A;

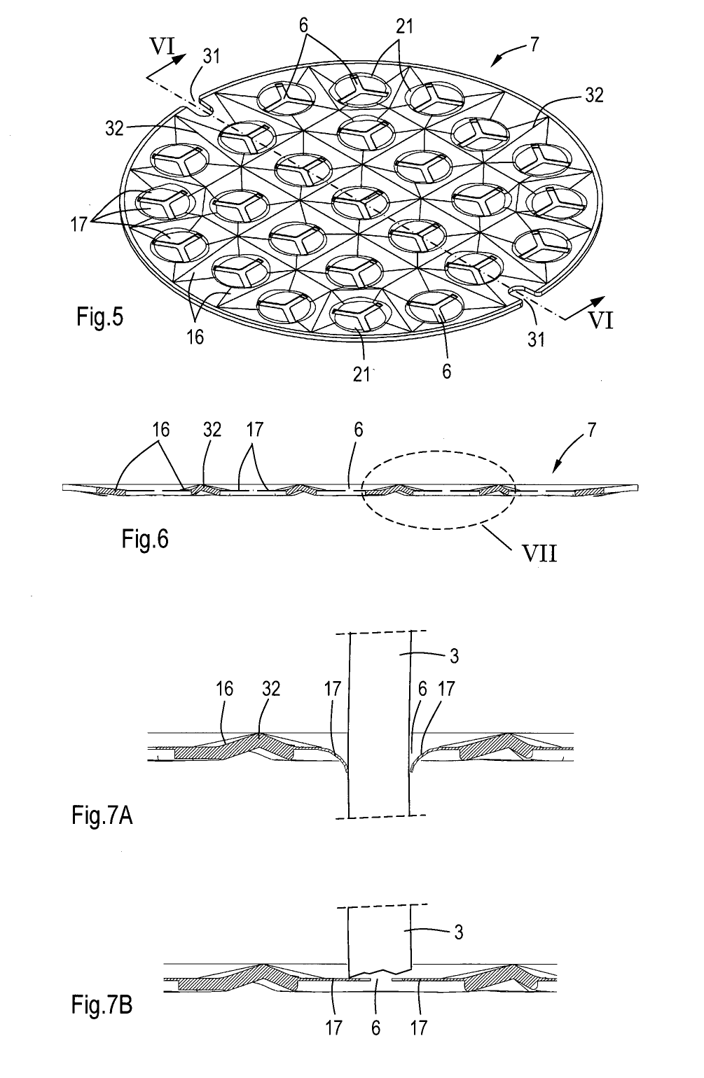

FIG. 5 shows the grid plate according to the invention;

FIG. 6 shows the cross section VI-VI of FIG. 5;

FIG. 7A shows an enlarged view of VII of FIG. 6;

FIG. 7B shows the flower stem of FIG. 7A just before the insertion;

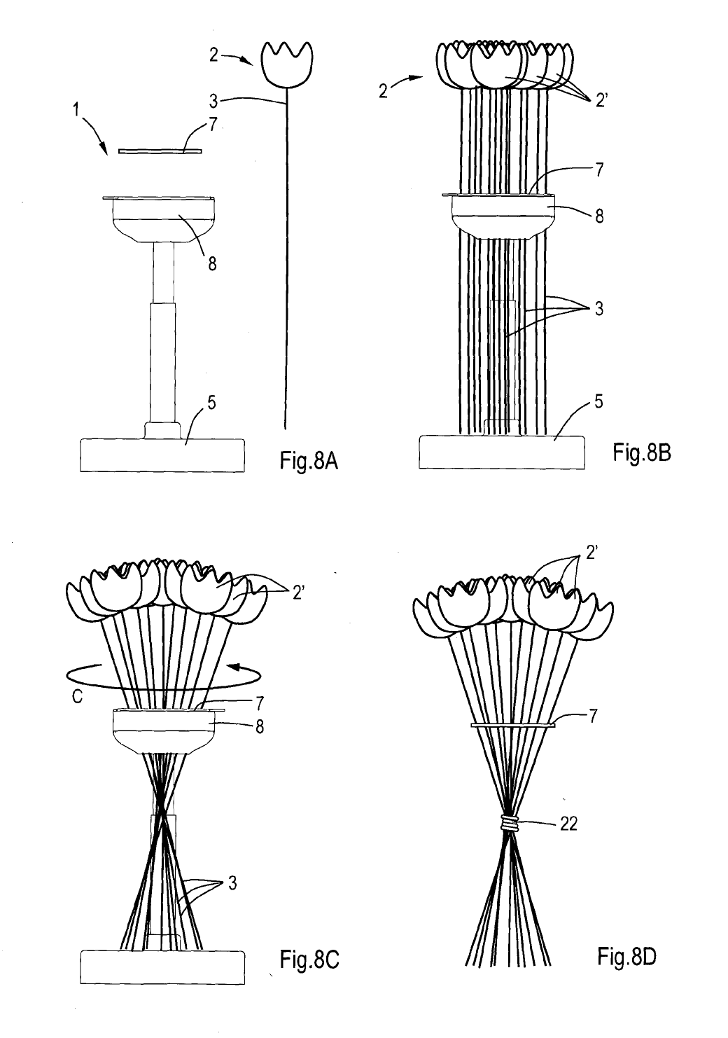

FIG. 8A shows a front view of the device of the invention before the insertion of the flowers;

FIG. 8B shows the flowers inserted parallel to each other in the device;

FIG. 8C shows the rotation of the upper grid to form a corn-sheaf-like bunch of flowers;

FIG. 8D shows the corn-sheaf-tied bouquet with the grid plate positioned therein;

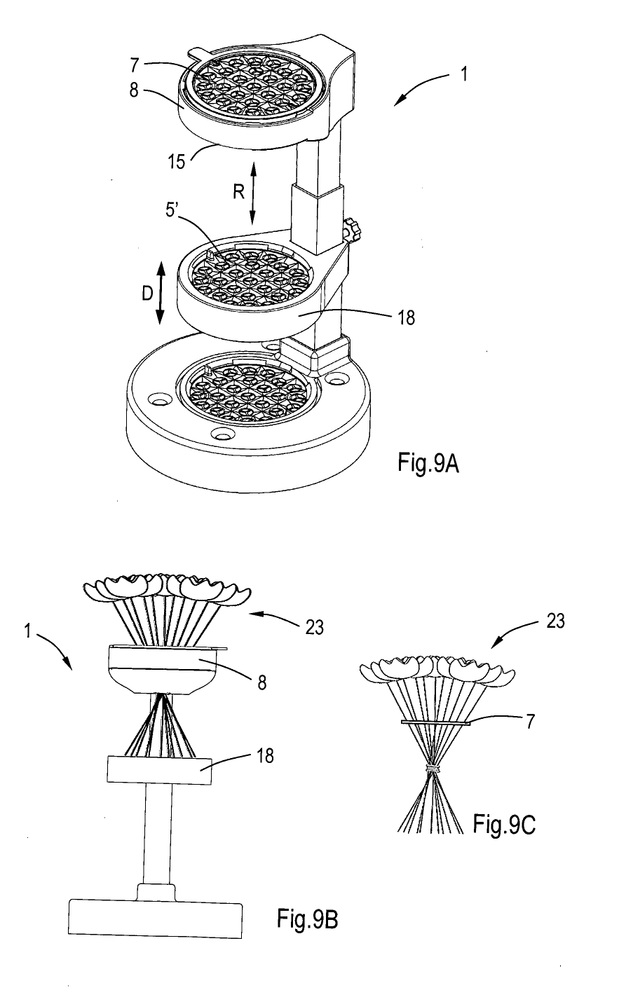

FIG. 9A shows a device with a third grid holder;

FIG. 9B shows the formation of a Biedermeier bouquet with the corn-sheaf technique;

FIG. 9C shows a corn-sheaf-tied Biedermeier bouquet with the grid plate positioned therein;

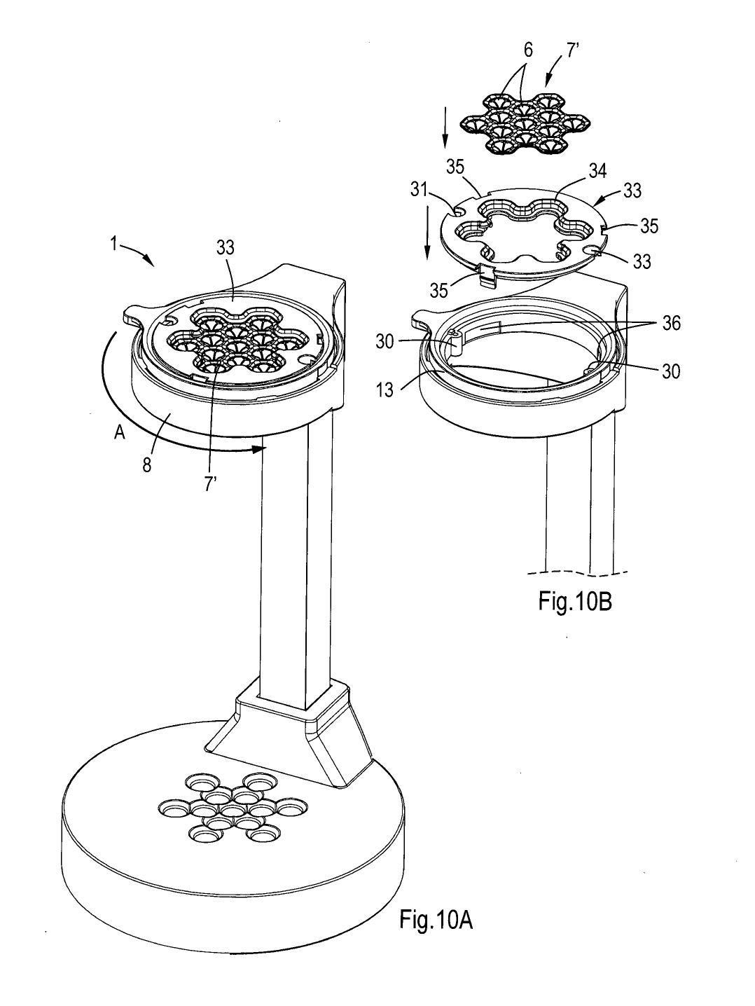

FIG. 10A shows an alternative embodiment of the device according to the invention with a grid plate in an adapter;

FIG. 10B shows an exploded view of the embodiment shown in FIG. 10A;

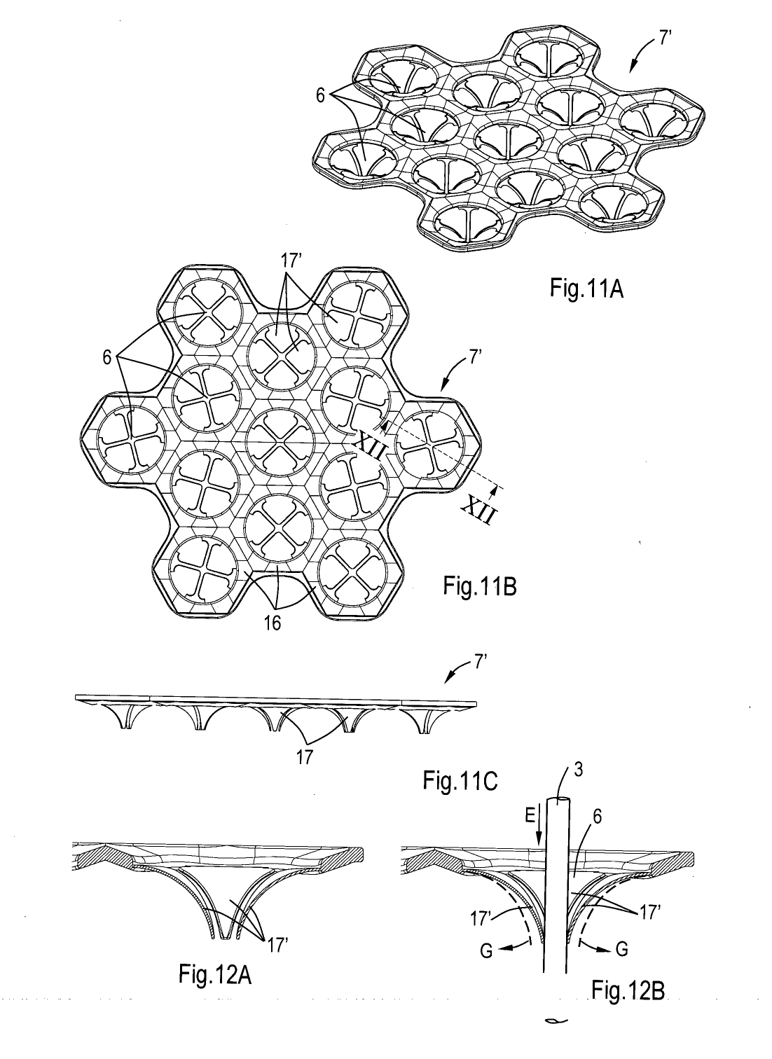

FIG. 11A shows an alternative embodiment of a grid plate;

FIG. 11B shows a top view of the grid plate of FIG. 11A;

FIG. 11C shows a side view of the grid plate of FIG. 11A;

FIG. 12A shows an enlarged view of XII-XII of FIG. 11B;

FIG. 12B shows a stem during insertion into the opening of FIG. 12A;

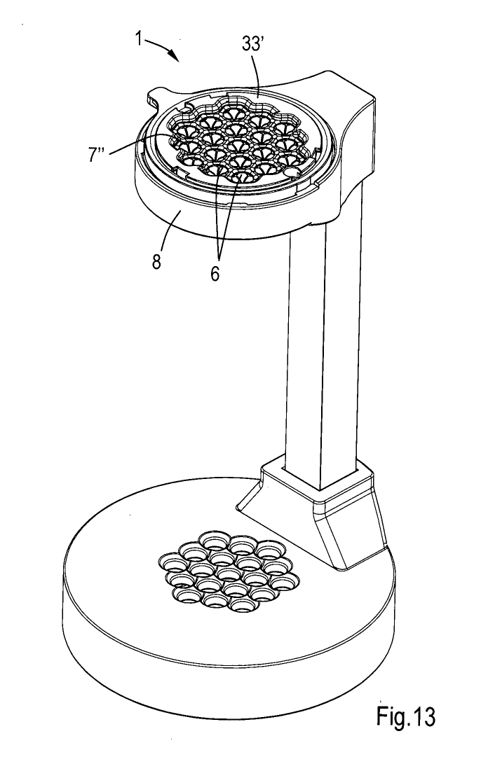

FIG. 13 shows the device with a grid plate provided with nineteen openings in an appropriate adapter.

FIG. 1 shows the device 1 according to the invention for use in the process of arranging a bunch or bouquet of flowers with of corn-sheaf-bound (twisted-bound) flower stems having a first upper grid plate 7 within a first upper grid holder 8 and a second lower grid plate 5 in a second lower grid holder 9. The grid plates 7, 5 both are provided with openings 6, 6′, whereby the openings 6, 6′ are provided with a size suitable for inserting through flower stems for arranging and binding of a corn-sheaf-like bunch of flowers. The upper grid plate 7 is detachably and rotatably received in the upper grid holder 8 of the device 1, so that after arranging the bunch of flowers and after optionally tying together of the stems of the bunch, the grid plate 7 can be removed from the grid holder 8, thereby remaining positioned in the bouquet of flowers. The upper grid holder 8 is provided with means, such as a handle 19, in order to be able to rotate the upper grid. The lower grid plate 5 is non-rotatably mounted into the second grid holder 9 of the device. In this embodiment the lower grid plate 5 is identical to the upper grid plate 7. Fixing means are provided in order to prevent rotation of the lower grid plate 5 within the second grid holder. In FIG. 1 the fixing means are embodied in a rib 30′ being provided on the second grid holder and a corresponding recess 31′ on the outer edge of the grid plate 5.

In FIG. 2 it is shown how the grid plate 7 by means of a handle 19 is rotated in the first grid holder in the direction of arrow A. The upper grid plate 7, being able to rotate relative to the lower grid plate 5 around a (virtual, imaginary) axis of rotation, which is substantially perpendicular oriented with respect to the surface 20 of the grid plates, facilitates forming a corn-sheaf-like bouquet having a symmetrically shape in a simple manner with the device, from a number of flower stems inserted through both grid plates. By rotating the upper grid plate 7 and by fixing the lower grid plate, undesirable reverse twisting or rotating is prevented after the formation of the corn-sheaf-bound bouquet, so that the user can use both hands during binding of the flower stems.

Moreover, it is for the user lighter and easier to rotate the upper grid plate, since the centre of gravity of the flowers in general is located high. The rotation of the upper part of the bouquet, with the handle 19 by one hand of a user, is aided by exercising a rotational force on the crown of flowers (with the free hand).

In FIG. 3 is shown, with the arrow B, how the upper grid plate 7 is removed from or inserted into the first grid holder 8. The grid plate 7 and the grid holder 8 may be provided with fixing means such as an protruding vertical rib 30 on the grid holder 8, and therewith corresponding recesses 31 on the grid plate 7, so that the grid plate rotates around a vertical axis of rotation when the handle 19 is moved about the circular circumference of the grid holder 8.

In FIGS. 4A and 4B, in cross-section in more detail, the device 1 for use in the process of arranging flowers is shown with the assembling parts of the rotating mechanism. The first grid holder 8 in this embodiment comprises a fixed holder body 10, which is provided with a cylindrical pivot recess 11 and a support ring 12. Furthermore a rotary ring 13 is provided in the pivot recess 11, wherein the rotary ring 13 rests upon the support ring 12. The rotary ring 13 is suitable for receiving the grid plate 7, which is provided with openings 6 for receiving and also for supporting the stems of the flowers. The rotary ring 13 may be provided with aiding tools, such as a handle 19 for rotating the rotary ring 13 and the grid plate 7, which is non-rotatably mounted therein. This assembly has the advantage that it is simple to manufacture, that it is robust, and that it prevents reverse rotation of the grid plate and of the corn-sheaf shaped bouquet. Furthermore the assembly secures lightly rotating of the grid plate 7, and enables at the same time the use of aiding tools, such as a rotational aid in the form of a handle 19.

In FIGS. 4A and 4B is further shown an adjustment mechanism 14 to allow for adjustment in the vertical direction of the first and the second grid holder relative to one another. In this example, by means of the telescopically mutually inserted uprights, the first grid holder 8 can be adjusted to and from the second lower grid holder 9, so that the space R between the underside 15 of the first grid holder 8 and the second grid holder 9 can be adjusted to the length of the stems for the bouquet to be arranged. Alternatively the second grid holder 9 including the therein-positioned lower grid plate 5 can be made adjustable, thereby being able to reduce the space R. In an alternative embodiment a third adjustable grid holder 18 provided, as shown in FIG. 9A-9C.

In FIG. 8A-8D, the method of operation of the device 1 is further shown in more detail. Firstly a grid plate 7 is placed in the upper grid holder 8, as already shown by arrow B in FIG. 3. Subsequently (cut) flowers 2 with their stems 3 are inserted into the device 1 by inserting the flower stems 3 firstly through the openings 6 of the upper grid plate 7, and subsequently inserting the flower stems 3 through the openings 6′ of the lower grid plate 5. FIG. 8B shows a number of flowers 2 with flower heads 2′ being inserted with their stems 3 into the upper grid plate 7 and into the lower grid plate 5. FIG. 8C shows the rotational movement according to arrow C of the upper grid plate 7 in the first grid holder 8 causing the bunch of flowers stems 3 to be arranged or twisted into a corn-sheaf-like bunch, i.e. into the shape of a double cone. Optionally a tie 22 can subsequently be arranged around the stems of the bunch 3 in order to fixate the corn-sheaf shape. In general this binding will be affixed to the narrowest, constricted part of the double-cone shape of the twisted bunch of flower stems 3. FIG. 8D shows the corn-sheaf-bound bunch of flowers 2 after it has been taken out from the device by removing the grid plate 7 out of the grid holder 8. The grid plate 7 remains positioned within the bunch of flowers somewhere between the tie 22 and the flower heads 2′ thereby granting the flower stems lateral support. As a result the bunch maintains its double-cone shape and its bulky appearance, even if the bunch is transported, or is put on display by the purchaser or user by inserting the bunch into a vase.

FIG. 5 shows in further detail a grid plate 7 according to the present invention. In this embodiment the grid plate has a circular shape and is provided with twenty-five openings 6. The number of openings 6 is preferably adapted to the amount of the flowers in the bunch to be arranged, but obviously also only a part of the openings may be used, when a bunch is to be assembled or arranged having fewer flowers. When a bunch of nine flowers must be arranged, for example, a grid plate with nine openings will be manufactured for use in the device, or only the centre nine openings 6 of the existing grid plate 7 may be filled. The grid plate is provided with fixing means, which prevent undesirable rotation of the grid plate, in the example of FIG. 5 the fixing means being embodied by recesses 31 for receiving radially extending ribs or projections provided upon the holder body for the grid plate, such as a adapter piece 33 or a rotary ring 13. Preferably an upper grid plate 7 can also be applied as a fixed lower grid plate 5.

The openings 6 of the grid plate 7 in the embodiment of FIG. 5 are provided with one or more bevelled surfaces 16, which decline in the direction of the centre of the opening. As a result the flower stems 3 are guided to the opening during their insertion, so that the insertion of the stems is less difficult and requires less time. In the example of FIG. 5 four or five bevelled surfaces 16 per opening are applied. The bevelled surface may also be a round hollow or concave shaped surface that guides the stems to the opening 6. In this embodiment the openings 6 are provided with clamping means in the form of lips 17, which extend from the edge 21 of the opening towards the centre of the opening. In FIG. 6 and FIGS. 7A and 7B these clamping means are shown in more detail.

In this example, each opening 6 on its (circumferential) edge 21 is provided with three lips being provided with the form of a slice of a pie or a circle segment. The lips do not connect to each other in the middle of the opening 6 so that a free space is formed, shaped as a three-legged cross. The lips 17 can also be provided with other shapes, provided that the lips 17 are flexible and resilient, so that the flower stem 3 is clamped in the opening 6 of the grid plate 7.

FIG. 6 shows the grid plate 7 in cross-section VI-VI of FIG. 5. The bevelled surfaces 16 are formed between the raised ribs 32. The lips 17 extend into the openings and are provided with a smaller thickness. The raised ribs 32 define the surfaces surrounding the opening, preventing slipping away of flower stems during insertion to an adjacent opening 6, so that the insertion of flower stems by the user through the grid plates will proceed faster and more efficiently.

FIG. 7A shows, in an enlarged representation of VII of FIG. 6, a flower stem 3 which is disposed into the opening 6, and also shows the flexible clamping means in the form of lips 17 within the opening. As a result of the insertion of the flower stem from above, the lips are bent down and thereby exert a clamping force on the flower stem 3. The lips 17 are provided with such a flexibility that the stem 3 is not damaged during insertion, but that the flower stem is sufficiently clamped in such a way, that the grid plate 7 remains clamped in the bunch after removal from the device. The lips 17 may also be provided with a barb function, which makes it less difficult to insert a stem through the opening provided with lips, than to remove the stems in the opposite direction out of the opening. Big and tall and even overlapping lips will have a stronger barb effect than short lips.

FIG. 7B shows the flower stem 3 of FIG. 7A, just before the insertion, wherein the lips 17 have a horizontal orientation in the plane of the grid plate.

FIG. 9A shows an alternative embodiment of the device 1 having a third grid holder 18. The third grid holder 18 can be adjusted, according to the arrow D, towards a position just under the first grid holder 8. The third grid holder 18 is provided with a third grid plate 5′ for inserting of the bottom part of the flower stems 3. By applying the third grid holder 18, the space R between the third grid plate 5′ and the bottom side 15 of the first grid holder 8 can be shortened even further, so that also very small and short bouquets can be arranged with the device.

FIG. 9B shows how, analogous to FIG. 8C, the third grid holder 18 is used for the process of arranging a small bouquet 2, such as a Biedermeier. The term Biedermeier is used for a round flower-rich flower-arrangement with short-stemmed flowers, often in the form of a compact hemisphere.

FIG. 9C shows the formed (Biedermeier) bouquet 2 with the therein-included grid plate 7. The grid plate 7 thereby ensures that the bouquet retains it (Biedermeier) shape, even after the bouquet and the grid plate are removed from the device 1 and even during transportation and sales of the bouquet. Even during use, display and exhibition of the bouquet by the user the grid plate enables maintaining the initial shape of the bouquet.

The grid plate 7 may be applied in the first grid holder of the device, but it is also possible to use the same grid plate as a lower grid plate 5 in the second grid holder 9, or as third grid plate 5′ in the third grid holder 18.

FIG. 10A, FIG. 10B show a second alternative embodiment of the device 1 according to the present invention provided with a grid plate 7′, having thirteen openings 6, and with an adapter piece or plate 33. Grid plate T has a peripheral shape which is determined by the design of the bouquet and by the selected configuration and pattern of the openings 6. The portions of the grid plate which are not provided with openings have been removed. As a result, the grid plate 7′ has not the shape of a disc, and it is not possible to place the grid plate 7′ into the cylinder-shaped rotary ring 13 for rotation in the direction of arrow A. The rotary ring 13 must therefore be adapted to the peripheral shape of the grid plate 7′. This adjustment can be achieved in an advantageous manner by the application of an intermediate piece, a transition piece i.e. adapter 33, shown in FIG. 10B in the form of an adapter plate 33. This adapter plate 33 is provided with a fitting hole 34, which has the same peripheral shape as the grid plate 7′. The edge of the fitting hole 34 is provided with means to prevent falling of the grid plate 7′ through the opening and to enable the grid plate 7′ to be rotated by the rotary ring 13. These means can be a bearing edge or support edge, but can also be embodied as an edge, which tapers smaller in the direction of the bottom. The adapter plate 33 and the rotary ring 13 can also be provided with additional fixing means, such as ribs 30, and therewith co-operating recesses 31 and protruding parts such as snap elements 35 which optionally co-operate with snap-slots 36.

FIG. 11A, 11B shows in greater detail the grid plate 7′ of FIGS. 10A, 10B with thirteen openings 6. The openings 6 are fitted together as hexagons, so that six openings fit in a first circle around the centre opening. Of the second circle alternating six openings are omitted so that the grid plate 7′ has a peripheral shape consisting of six protruding openings separated by six recesses. The openings 6 are also, like in FIG. 5, provided with bevelled surfaces 16, which decline in the direction of the centre of the opening. The openings 6 are also provided with clamping means, embodied as four long lips 17′, each having the shape of a wedge or circular sector. The lips are not (inter)connected or touching each other in the middle of the opening 6 so that a free space in the form of a four-legged cross is formed. A grid plate 7′, 7″ having a peripheral shape defined by the configuration and pattern of the openings—without flat edge portions for obtaining a disc-shaped circular peripheral shape—has the advantage that the grid plate is less clearly visible within the bouquet, and also has the advantage that the contours are less visible through the package, for instance when the bouquet is wrapped (tightly) into a wrapping paper, or is inserted into a flower sleeve.

FIG. 11C shows a side view the long lips 17′ protruding from the underside of the opening. The lips 17′ have a triangular downwardly curved shape. The four lips 17′ of the opening 6 are in the downward direction provided with a curved shape in such a way that the four outer ends are coaxially oriented in the middle of the opening 6. Viewed from the outside, the four lips 17′ constitute a body with concavely extending sides.

FIGS. 12A & 12B shows, in an enlarged view of XII-XII of FIG. 11B, a flower stem 3, which is inserted into the opening 6, and also shows the flexible clamping means shaped as lips 17′ in the opening 6, which are outwardly bent by the flower stem 3 from the centre in the direction of arrows G and thereby exerting a clamping force on the flower stem 3. The lips 17 are provided with such a flexibility that the flower stem 3 will not be damaged during insertion, and that the flower stem is clamped sufficiently in such a way that the grid plate 7′ remains clamped in the bunch after removal from the device. Chance of damage to the flower stem 3 is minimized because, with respect to FIGS. 5-7B, the lips 17′ are long and their ends are downwardly bent into a coaxial position so that during the insertion of the flower stem the concave portions of the lips substantially flatly abut against the surface of the stem and slide over the surface of the flower stems, so that the outer ends of the lips, in the direction of arrow G, are moved away from the stem and are not in contact with the stem. During removal of the stem, in the reverse direction of arrow E in FIG. 12B, the lips 17′ have a small effect as a barb, caused by the concave shape of the lips, whereby damaging of the stem is prevented when it is displaced in the reverse direction of arrow E.

FIG. 13 shows the device 1 according to the invention provided with a grid plate 7″ having nineteen apertures 6 and a matching adapter plate 33′. By completely filling the second circle of the grid plate 7′ of FIG. 11B by adding six openings 6, a grid plate 7″ is obtained with nineteen openings 6.

The device and the grid plate according to the invention are preferably manufactured from known plastic materials such as polypropylene or polyethylene, but may also be made from other thermoplastics, thermosets, or from metal or from a combination of various materials.

1-20. (canceled)

21. A device for use in arranging a plurality of flowers into a bouquet of flowers with corn-sheaf-bound flower stems, the device comprising:
a first upper grid plate including a plurality of openings sized and configured to receive flower stems from a plurality of flowers;
a second lower grid plate including a plurality of openings sized and configured to receive the flower stems from the plurality of flowers, the first upper grid plate and the second lower grid plate being disposed in a substantially parallel and a substantially horizontal orientation, the first upper grid plate and the second lower grid plate being rotatable relative to one another about a common, substantially vertical, axis of rotation, the first upper grid plate remaining positioned in the bouquet of flowers after arranging the flowers; and
a support structure supporting the first upper grid plate and the second lower grid plate, the first upper grid plate rotatably mounted to the support structure, the second lower grid plate non-rotatably mounted in the support structure.

22. The device according to claim 21, wherein the upper grid plate is a substantially circular flat disc; and
wherein the plurality of openings are substantially arranged in regular equal distances from each other.

23. The device according to claim 21, further comprising a first upper grid holder that holds the first upper grid plate and a second lower grid holder that holds the second lower grid plate.

24. The device according to claim 23, wherein the first upper grid holder receives the first upper grid plate and the upper grid plate is rotatable relative to the first upper grid holder.

25. The device according to claim 23, wherein the second lower grid holder non-rotatably receives the second lower grid plate; and
wherein the second lower grid holder and the second lower grid plate further comprise fixing means for fixing the second lower grid plate relative to the second lower grid holder.

26. The device according to claim 23, wherein the first upper grid holder further comprises a holder body and a rotary ring rotatable about the axis of rotation, the rotary ring sized and configured to receive the first upper grid plate.

27. The device according to claim 26, wherein the rotary ring and the first upper grid plate further comprise fixing means for fixing the first upper grid plate relative to the rotary ring.

28. The device according to claim 26, wherein the holder body further comprises a cylindrical pivot recess and a support ring, the rotary ring at least partially disposed in the cylindrical pivot recess and resting upon the support ring.

29. The device according to claim 21, further comprising a first upper grid holder and an adapter piece with a fitting hole, the adapter piece adapted to receive the first upper grid plate and attach the first upper grid plate to the first upper grid holder.

30. The device according to claim 23, further comprising an adjustment mechanism for adjusting a distance between the first upper grid holder and the second lower gird holder.

31. The device according to claim 23, wherein the second lower grid holder and the second lower grid plate are adjustable in a vertical direction so that a space between the second lower grid plate and a bottom side of the first upper grid holder can be adjusted.

32. The device according to claim 23, further comprising a third grid holder that is sized and configured to receive a third grid plate, the third grid holder adjustable in a vertical direction so that a space between the third grid plate and a bottom side of the first grid holder can be adjusted.

33. A method for arranging a plurality of flowers into a corn-sheaf-bound bouquet, the method comprising:
inserting an upper grid plate including a plurality of openings sized and configured to receive flower stems from a plurality of flowers into an upper grid plate holder;
inserting a lower grid plate including a plurality of openings sized and configured to receive flower stems from a plurality of flowers into a lower grid plate holder;
inserting flower stems from a plurality of flowers through the plurality openings in the upper grid plate and through the plurality of openings in the lower grid plate;
rotating the upper grid plate for obtaining a twisted bunch of flower stems with a double-cone shape;
applying a tie at least proximate the narrowest part of the double-cone shape of the twisted bunch of flower stems; and
removing the corn-sheaf-bound bouquet and the upper grid plate.

34. A grid plate for use in a device for arranging a plurality of flowers into a corn-sheaf-bound bouquet, the device comprising a first upper grid plate including a plurality of openings sized and configured to receive flower stems from the plurality of flowers, a second lower grid plate including a plurality of openings sized and configured to receive flower stems from a plurality of flowers, the first upper grid plate and the second lower grid plate being disposed in a substantially parallel and a substantially horizontal orientation, the first upper grid plate and the second lower grid plate being rotatable relative to one another about a common, substantially vertical, axis of rotation, wherein the first upper grid plate is arranged to be able to remain positioned in the bouquet of flowers after arranging the flowers, the grid plate comprising:
a generally planar body including a plurality of openings disposed in the body, the plurality of openings sized and configured to receive flower stems from a plurality of flowers, wherein the grid plate may comprise the first upper grid plate or the second lower grid plate.

35. The grid plate according to claim 34, wherein the openings include one or more bevelled surfaces which decline in the direction of the opening.

36. The grid plate according to claim 34, further comprising ribs disposed between two adjacent openings.

37. The grid plate according to claim 34, wherein each opening of the plurality of openings include one or more lips which extend towards a center of the opening, the lips being flexible and resilient to clamp the flower stems of the flowers in the opening.

38. The grid plate according to claim 34, wherein a peripheral shape of the grid plate is defined by a configuration and a pattern of the plurality of openings.

39. The grid plate according to claim 38, wherein the lips located on an underside of the grid plate are concavely curved and outwardly extending; and
wherein an end of the lips have a substantially coaxial position.

40. The grid plate according to claim 34, wherein the first upper grid plate is rotatable about the axis of rotation; and
wherein the second lower grid plate is fixed relative to the axis of rotation.
